(19) United States
(12) Patent Application Publication
(10) Pub. No.: US 2026/0259599 A1
(43) Pub. Date: Sep. 3, 2026

(54) METHOD AND DEVICE OF MOTION CONTROL FOR A DISPLAY OBJECT

(71) Applicant: Beijing Zitiao Network Technology Co., Ltd., Beijing (CN)

(72) Inventor: Pengjing Song, Beijing (CN)

(21) Appl. No.: 18/858,239

(22) PCT Filed: Mar. 31, 2023
(86) PCT No.: PCT/CN2023/085652

§ 371 Date: Oct. 18, 2024

(30) Foreign Application Priority Data
Apr. 20, 2022 (CN) 202210416545.5

(51) Int. Cl. G06F 3/01; G06T 7/246; G06T 7/73

(52) U.S. Cl. CPC G06F 3/012; G06T 7/246; G06T 7/73; A63F 13/21; A63F 13/428; A63F 2300/1087; A63F 2300/1093; G06F 3/013; G06T 2207/30201

(57) ABSTRACT

A method and device of motion control for a display object are provided. The method includes: acquiring (S101) facial feature data of a user; updating (S102) a current motion velocity of the display object based on the facial feature data; and controlling (S103) the display object to move in the display interface based on the updated current motion velocity. The method maps facial feature data to a motion velocity first, so as to control a display object to move by means of the motion velocity. In this way, when facial feature data changes, a motion velocity of a display object changes, and the changing of the motion velocity can make a position of the display object after moving uncertain. Thereby, a relative position relationship between the display object and a face is diversified, which improves the diversity of the motion of the display object.

### CROSS REFERENCE

This application claims priority to Chinese Patent Application No. 202210416545.5, filed with the Chinese Patent Office on Apr. 20, 2022 and entitled ‘METHOD AND DEVICE OF MOTION CONTROL FOR A DISPLAY OBJECT’, which is incorporated herein by reference in its entirety.

### FIELD

Embodiments of the present disclosure relate to the field of motion control technologies, and in particular, to a method and device of motion control for a display object.

### BACKGROUND

In the technical field of motion control, a user can control the motion of a display object so as to experience fun. There are various manners for the user to control the display object, wherein a traditional control manner may be control via an input device such as a keyboard or a mouse. In order to further improve the enjoyment of the user, the user may also control the motion of the display object via the face.

In conventional solutions, the motion control of a display object can be implemented by means of a relative position relationship between a feature point position in a face and the display object. Specifically, firstly, the solution for controlling the motion of the display object via the face requires capturing an image of the user's face in order to recognize a feature point position in the face from the face image; then, the position of the display object in the display interface is updated based on the feature point position and a predetermined relationship of the aforementioned relative position. In this way, the position of the display object changes in response to changes in the position of the facial feature point, and the purpose of controlling the motion of the display object via the face is implemented.

However, there is a problem in conventional solutions that the motion of the display object is single.

### SUMMARY

Embodiments of the present disclosure provide a method and device of motion control for a display object, which can improve the motion diversity of the display object.

In a first aspect, embodiments of the present disclosure provide method of motion control for a display object, comprising:
acquiring facial feature data of a user;
updating a current motion velocity of the display object based on the facial feature data; and
controlling the display object to move in the display interface based on the updated current motion velocity.

In a second aspect, embodiments of the present disclosure provide an apparatus for motion control for a display object, comprising:
a feature data acquiring module configured to acquire facial feature data of a user;
a motion velocity updating module configured to update a current motion velocity of the display object based on the facial feature data; and
a motion controlling module configured to control the display object to move in the display interface based on the updated current motion velocity.

In a third aspect, embodiments of the present disclosure provide an electronic device, comprising: at least one processor and a memory; wherein
the memory stores computer execution instructions; and
the at least one processor executes computer execution instructions stored in the memory to cause the electronic device to implement the method of the first aspect.

In a fourth aspect, embodiments of the present disclosure provide a computer-readable storage medium having computer execution instructions stored therein, the computer execution instructions, when executed by a processor, causing a computing device to implement the method of the first aspect.

In a fifth aspect, embodiments of the present disclosure provide a computer program product comprising a computer program, which, when executed by a processor, implements the method of the first aspect.

In a sixth aspect, embodiments of the present disclosure provide a computer program for implementing the method of the first aspect.

### BRIEF DESCRIPTION OF THE DRAWINGS

To describe the technical solutions in the embodiments of the present disclosure or in conventional solutions more clearly, a brief description of the accompanying drawings to be used in the description of the embodiments or conventional solutions will be given bel ow, and it will be apparent that the accompanying drawings in the following description are some of the embodiments of the present disclosure, and that other accompanying drawings may be obtained from these drawings for a person of ordinary skill in the art without creative labor.

FIG. 1 is a schematic diagram of a relative position relationship between a feature point position and a display object in conventional solutions;

FIG. 2 is a flowchart of a method of motion control for a display object according to an embodiment of the present disclosure;

FIG. 3 is a schematic diagram of a facial rotation angle according to an embodiment of the present disclosure;

FIG. 4 is a schematic diagram of updating a motion path according to an embodiment of the present disclosure;

FIG. 5 is a schematic diagram of correspondence between two-dimensional coordinates of a facial feature point and a current motion direction of a display object according to an embodiment of the present disclosure;

FIG. 6 is a structural block diagram of an apparatus for motion control for a display object according to an embodiment of the present disclosure;

FIG. 7 is a block diagram of an electronic device according to an embodiment of the present disclosure; and

FIG. 8 is a block diagram of another electronic device according to an embodiment of the present disclosure.

### DETAILED DESCRIPTION

In order to make the purpose, technical solutions and advantages of the embodiments of the present disclosure clearer, the technical solutions in the embodiments of the present disclosure will be described clearly and completely in the following in conjunction with the accompanying drawings in the embodiments of the present disclosure, and it is clear that the described embodiments are a part of the embodiments of the present disclosure, and not all of the embodiments. Based on the embodiments in the present disclosure, all other embodiments obtained by a person of ordinary skill in the art without making creative labor fall within the scope of protection of the present disclosure.

As described in the background art, there is a problem in conventional solutions that the motion of the display object is single. After analyzing the conventional solutions, the inventor found that one of the reasons for the aforesaid problem is that the relative positional relationship between the feature point position and the display object is always the same. This results in the motion of the display object always being consistent with the motion of the face, and the motion of the display object being more singular.

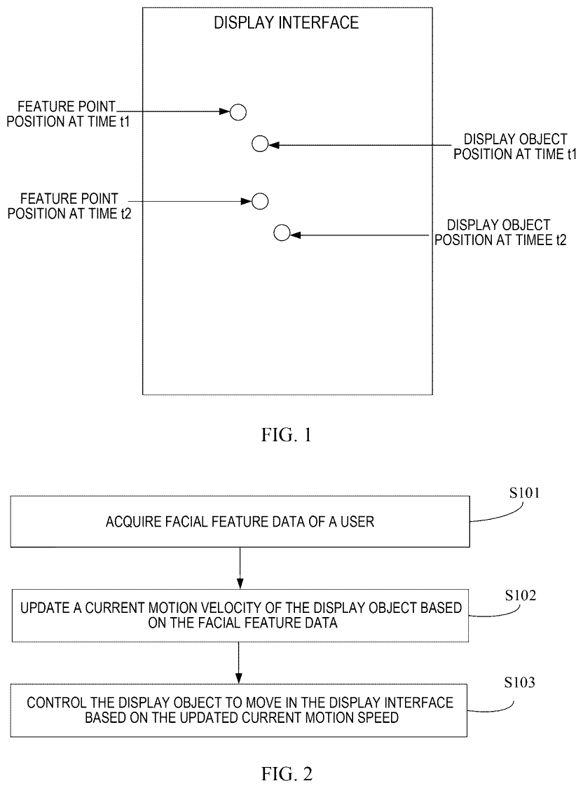

FIG. 1 is a schematic diagram of a relative position relationship between a feature point position and a display object in conventional solutions. Referring to FIG. 1, at time t1, the display object is located at the lower right of the feature point position. At time t2, the display object is still located at the lower right of the feature point position, and the relative positional relationship between the two is consistent.

In order to solve the described problem, it is considered in the embodiments of the present disclosure that the motion of the display object may be diversified by diversifying the relative position relationship between the face and the display object. In order to implement the diversification, it is considered to map facial feature data to a motion velocity first, so as to control a display object to move by means of the motion velocity. In this way, when facial feature data changes, a motion velocity of a display object changes, and the changing of the motion velocity can make a position of the display object after moving uncertain, thereby diversifying a relative position relationship between the display object and a face.

The technical solutions of the embodiments of the present disclosure and how the technical solutions of the present disclosure solve the above technical problems are described in detail below by way of specific embodiments. These following specific embodiments may be combined with each other, and the same or similar concepts or processes may not be repeated in some embodiments. Embodiments of the present disclosure will be described below in conjunction with the accompanying drawings.

FIG. 2 is a flowchart of a method of motion control for a display object according to an embodiment of the present disclosure. The display object herein may be any object presented on the display screen of the electronic device, and the display object may be understood as a virtual object. Optionally, the display object may be a 3D (three-dimensional) virtual object. In different application scenarios, the display object is different. An application scenario of an embodiment of the present disclosure is a game scenario. In the game scenario, a game interface may be presented on a display screen, and a display object may be understood as a game role. The game role may move in the game interface. The motion may be controlled by a game player. It should be noted that the application scenario of the embodiment of the present disclosure is not limited to the foregoing game scenario, and thus the display object is not limited to the foregoing game character.

Referring to FIG. 2, the method of motion control for a display object comprises the following.

At S101, facial feature data of a user is acquired.

Herein, the facial feature data is an expression of a facial feature on data, and a change thereof can reflect a change of the facial feature. It should be noted that the facial feature data may be any feature specific to a facial feature, for example, a position of a facial feature point, a rotation angle of the face, and the like.

In an embodiment of the present disclosure, the facial feature data may comprise a plurality of one-dimensional sub-data: two-dimensional coordinate values of a facial feature point, a facial rotation angle on at least one plane, and a size of a facial region.

Herein, the two-dimensional coordinate values of the facial feature point are components of the facial feature point in two dimensions of coordinate positions in the two-dimensional facial image. For example, the coordinate position may be (x, y), and the two-dimensional coordinate values of the facial feature point may comprise two values of x and y.

It should be noted that the facial feature point may be any feature point in the face, comprising but not limited to eyes, nose, ears, eyebrows, mouth, and the like. The positions of the facial feature points may represent the facial motion, so that the facial motion features may be represented based on the two-dimensional coordinate values of the facial feature point, so as to control the motion of the display object.

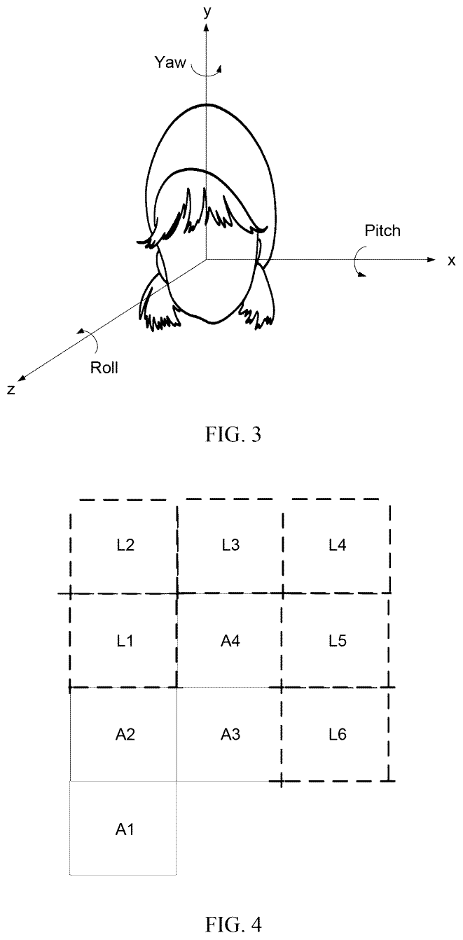

The facial rotation angle is used to represent a rotation state of a face and is a vector that can represent a rotation amplitude and direction of the face of the user in a real three-dimensional space. In practical applications, a plurality of rotation axes may be set in a real three-dimensional space, so that each rotation axis corresponds to a facial rotation angle and is used to represent a rotation amplitude and direction when rotation is performed around the rotation axis. In order to represent rotation in each direction with as few rotation axes as possible, three rotation axes perpendicular to each other may be provided in the three-dimensional space. FIG. 3 is a schematic diagram of a facial rotation angle according to an embodiment of the present disclosure. In FIG. 3, three coordinate axes in a real three-dimensional space are used as three rotation axes. Referring to FIG. 3, a three-dimensional coordinate system is established as shown in FIG. 3, with Pitch, Yaw, and Roll representing the angles of rotation in the three planes. Herein, Pitch is the facial rotation angle in the YOZ plane, which is the facial rotation angle around the x-axis. Yaw is the facial rotation angle in the XOZ plane, which is the facial rotation angle around the y-axis. Roll is the facial rotation angle in the XOY plane, which is the facial rotation angle around the z-axis.

It is to be understood that the facial rotation angle described above is used to represent a rotational motion of the face, so that the motion of the display object can be controlled by the facial rotation angle.

The above-mentioned facial rotation angle can be acquired by the following steps: first, a coordinate position of a facial feature point is obtained from the facial image by recognizing it with a facial recognition algorithm; then, a PNP (perspective-n-point) algorithm is carried out based on the coordinate position of this facial feature point and the coordinate position of a predetermined standard key point, and the above facial rotation angle can be obtained.

In addition to the facial rotation angle and the two-dimensional coordinate values of the facial feature points described above, the facial feature data may further comprise a size of a facial region. The size of the facial region may also be extracted from the facial image, and the size of the facial region increases during the motion of the face toward the screen. During the motion of the face back towards the screen, the size of the facial region decreases. Thereby, the dimensions of the facial region may also be used to represent changes in facial features to control the motion of the display object.

After obtaining the above-described multiple sub-data, the velocity of motion of the display object can be controlled by one or more of the above-described sub-data, and the specific control method can be described with reference to S102.

At S102, a current motion velocity of the display object is updated based on the facial feature data.

Herein, the correspondence between the current motion velocity and the facial feature data may be any correspondence. For example, when the coordinate position of the facial feature point represents that the face moves to the left, the motion velocity may be increased; when the coordinate positions of the facial feature points represent that the face moves to the right, the motion velocity may be reduced. For another example, when the facial rotation angle indicates that the face rotates downwards, the direction of the motion velocity may be adjusted downwards; when the facial rotation angle represents that the face is rotated upward, the direction of the motion velocity may be adjusted upward, etc. Certainly, the above correspondences are only some examples provided in the embodiments of the present disclosure and does not limit the correspondence between the current motion velocity and the facial feature data.

In embodiments of the present disclosure, the facial feature data may be converted into a target motion velocity of the display object, and then a current motion velocity of the display object may be updated based on the target motion velocity so that the current motion velocity may approximate the target motion velocity. The target motion velocity may be understood as a desired motion velocity of the display object. In this way, the current motion velocity can be gradually adjusted by the target motion velocity, and a discontinuity in the motion of the display object caused by an excessively large update amplitude of the current motion velocity can be avoided.

Herein, the current motion velocity and the target motion velocity of the display object are vectors, which may be represented as two-dimensional vectors or three-dimensional vectors to implement the motion of the display object in the two-dimensional space or the three-dimensional space. The two-dimensional or three-dimensional space in which the motion of the display object is located can be understood as a virtual space. Thereby, the above process of converting facial feature data to target motion velocity may be as follows: at least one one-dimensional sub-data of the facial feature data is mapped to a component of the target motion velocity in at least one dimension, i.e., for one of the dimensions in the virtual space, a component of the target motion velocity in that dimension is associated with the at least one sub-data.

It should be noted that, for one of the dimensions, the component of the target motion velocity in the dimension may be obtained by converting at least one piece of related sub-data, and the conversion may be linear conversion or non-linear conversion. In this way, compared with directly determining the sub-data as a component of the target motion velocity in the dimension, the component obtained after conversion can help to improve the diversity of the target motion velocity, thereby improving the motion diversity of the display object.

Certainly, compared with the linear conversion, the target motion velocity obtained by the non-linear conversion has a better diversity, thereby further improving the motion diversity of the display object.

In an example of an embodiment of the present disclosure, the sub-data associated with the components of the target motion velocity in various dimensions are two-dimensional coordinate values of a facial feature point. For example, the value of the facial feature point coordinate taken in the first dimension can be converted as the component of the target motion velocity in the first dimension, and the value of the facial feature point coordinate taken in the second dimension can be converted as the component of the target motion velocity in the third dimension.

In addition, the component of the target motion velocity in the second dimension can be set to 0. Thus, the target motion velocity V1=(f1(x1),0, f2(y1)) can be obtained. Herein, x1 is the value of the facial feature point coordinate in the first dimension, and y1 is the value of the facial feature point coordinate in the second dimension. f1 is a linear function or a non-linear function that converts x1, and f2 is a linear function or a non-linear function that converts y1. In this way, the velocity of the motion of the display object can be controlled by the motion of the facial feature points.

Alternatively, the size of the facial region may also be converted to be a component of the target motion velocity in the second dimension, so as to obtain the target motion velocity V1=(f1(x1), f3(s), f2(y1)), wherein s is the size of the facial region, and f3 is a linear function or a non-linear function for converting s. Herein, f1, f2, and f3 may be the same or different. In this way, in addition to the motion velocity of the facial feature point, the motion velocity of the display object may also be controlled through the facial size, so that the motion velocity of the display object may also be controlled when the face faces or moves away from the screen.

In another example of an embodiment of the present disclosure, the sub-data associated with the components of the target motion velocity in three dimensions is a facial rotation angle on at least one plane. For example, the facial rotation angle Rold in FIG. 3 may be converted to be a component of the target motion velocity in the first dimension, the facial rotation angle Yaw in FIG. 3 may be converted to be a component of the target motion velocity in the second dimension, and the facial rotation angle Pitch in FIG. 3 may be converted to be a component of the target motion velocity in the third dimension. In this way, the motion velocity of the display object may be controlled by the rotation of the face.

After the target motion velocity is obtained, the current motion velocity may be updated to approximate the target motion velocity based on a magnitude relation between the current motion velocity and the target motion velocity. Specifically, for any dimension in the three-dimensional space, it is determined whether the component of the target motion velocity in the dimension is greater than a component of the current motion velocity in the dimension. if yes, increasing the component of the current motion velocity in the dimension by a predetermined first acceleration, wherein the first acceleration is greater than 0. if yes, decreasing the component of the current motion velocity in the dimension by a predetermined second acceleration, wherein the second acceleration is less than 0.

Since the magnitude relationship between the current motion velocity and target motion velocity may be different in different dimensions, thus the component of the current motion velocity in this dimension needs to be updated based on the magnitude relationship in each dimension. For example, if the component of the current motion velocity in the first dimension is greater than the component of the target motion velocity in the first dimension, then the component of the current motion velocity in the first dimension needs to be decreased. Whereas the component of the current motion velocity in the second dimension is less than the component of the target motion velocity in the second dimension, then the component of the current motion velocity in the second dimension needs to be increased.

It can be seen that relative to updating the components on each dimension of the current motion velocity in the same way, the embodiments of the present disclosure update the current motion velocity separately for each dimension, which can update the current motion velocity more accurately, so that the current motion velocity better approximates the target motion velocity.

It is to be noted that the above first acceleration is used to increase the current motion velocity, and the second acceleration is used to decrease the current motion velocity. In practical applications, the acceleration in each dimension may be different to further improve the diversity of the motion velocity.

The above-described first acceleration and second acceleration may be set based on a time interval between two adjacent images. When the time interval is large, the first acceleration may be set to a larger value. When the time interval is small, the first acceleration may be set to a smaller value. The setting of the second acceleration is the same as the setting of the first acceleration and will not be repeated herein.

At S103, the display object is controlled to move in the display interface based on the updated current motion velocity.

It can be understood that the display interface is different in different application scenarios, for example, in a game application scenario, the display interface may be a game interface.

Specifically, first, a product of the updated current velocity of motion and a time interval between two adjacent frames of the image is determined as a motion vector of the display object; and then, a sum of a coordinate position of the display object in the current image and the motion vector is determined as a coordinate position of the display object in the next frame of the image to present the display object in the next frame of the image.

The above-described display object needs to move along a pre-generated motion path on a process which can be understood as a game process. During the game process, the user needs to control the motion of the display object on the motion path, and if the display object deviates from the motion path, the game is considered to have failed.

The aforesaid motion path may be generated by the following steps: first, acquiring a predetermined number of path components; then, generating a motion path of the display object based on the path components.

Herein, the path component is a software object for generating the motion path, the path component can be spliced into the motion path in order. The embodiments of the present disclosure can generate the motion path by a predetermined number of path components, which on the one hand can save computer resources, and on the other hand can improve the sense of urgency in conducting the game.

The process of splicing the motion path by the above path component may be divided into three stages.

In a first stage, the motion path is generated by any of a predetermined number of path components, when the motion path comprises only this one path component, the position of which may be randomly determined.

After splicing this first path component, the remaining unused path components may be sequentially spliced to obtain the motion path, which is the second stage.

In the second stage, a predetermined number of path components have not been used. Namely, if the predetermined number of path components comprise an unused path component, an unused path component is determined as a target path component to splice the target path component to a target adjacent position of a farthest path component in the motion path to obtain an updated motion path.

In the third stage, a predetermined number of path components are used up. If the predetermined number of path components do not comprise an unused path component, a nearest path component in the motion path is determined as a target path component to splice the target path component to a target adjacent position of a farthest path component in the motion path, to obtain an updated motion path. The nearest path component is the path component with the largest target splice time, the target splicing time of each path component is a time corresponding to a latest splicing of the corresponding path component to the motion path, and the farthest path component is a path component with a minimum target splicing time.

It can be seen that, other than the first path component, the splicing processes of the remaining path components are the same, and the generation process of the motion path is a process of sequentially splicing all path components.

For any target path component among the other path components, the corresponding target adjacent position may be any adjacent position of the farthest path component. In order to improve the interestingness of a game, the target adjacent position may be randomly selected from a plurality of adjacent positions of the farthest path component, and the adjacent positions may comprise, but are not limited to, front, back, left, right, right front, right back, left front and left back, etc.

Specifically, at each selection of the target adjacent position, a random number may be generated, and then the adjacent position corresponding to the value-taking interval in which the random number is located is determined as the target adjacent position. Herein, the correspondence between the value-taking interval and the adjacent position is predetermined. For example, if the random number takes values in the range of 0 to 1, then the value taking range can be divided into 8 value taking intervals corresponding to the following adjacent positions: front, back, left, right, right front, right back, left front and left back. In this way, if the generated random number is located in the value interval corresponding to the front, the front can be used as the target adjacent position.

In practice, the lengths of the value-taking intervals corresponding to different adjacent positions may be different, so that the prioritized adjacent positions may be adjusted by the lengths of the value-taking intervals. For example, the length of the value-taking interval corresponding to the front may be set to the maximum, so that the front may be preferentially selected as the target adjacent position, thereby causing the display object to preferentially move forward.

It will be appreciated that in the second stage described above, the unused path component may be spliced when the path component is not used up until the path components are all used up. Whereas, in the third stage described above, a decision on the timing of updating the motion path is required because all the path components have been used up, thereby requiring a decision on the timing of updating the motion path. At the time when the unused sections of the display object in the current motion path are long, the motion path may not be updated in order to reduce the number of operations and save computer resources. Not updating the motion path when the display object has a short untraversed section in the current motion path can result in the possibility that the display object may not be able to continue its motion, which can lead to an abnormal end of the game.

In summary, the motion path can be updated when the length of the untraversed section of the display object in the current motion path is appropriate. In this way, not only can the amount of arithmetic be reduced as much as possible to save computer resources, but also the display object can be guaranteed to have a path to travel, so as to avoid an abnormal end of the game.

Specifically, it can be determined whether the display object is located in the target intermediate position of the motion path based on the current coordinate position of the display object. When the display object is located in the target intermediate position of the motion path, the target path component is spliced to a target adjacent position of the farthest path component of the motion path, and the target intermediate position comprises a further position in the motion path other than the farthest path component.

Herein, the target intermediate position may be a centered position between the farthest path component and the nearest path component. The farthest path component and the nearest path component are located at a start position and an end position of the current motion path, respectively, and are updated as the motion path is updated. For example, if the current motion path are spliced from A1, A2, A3, A4, and A5, and the closest path component is A1 and the farthest path component is A5, then the closest path component is updated to A2, and the farthest path component is updated to A1, if A1 is spliced into a target adjacent position of A5.

As can be seen from the foregoing description, the target adjacent position is randomly selected from at least one adjacent position of the farthest path component. Alternatively, the process of randomly selecting the target adjacent position from the at least one adjacent position may comprise:

First, at least one adjacent position of the farthest path component in the motion path is acquired.

Then, it is determined whether at least one candidate position is present among the at least one adjacent position, wherein the candidate position comprises at least one of: a position other than a current position of the individual path component, or a position having at most one neighboring edge to the motion path.

Finally, if at least one candidate position is present among the at least one adjacent position, one position is selected randomly from the at least one candidate position as the target adjacent position. If no candidate position exists in at least one adjacent position, it is determined that no target adjacent position exists, and the motion path cannot be updated.

It can be seen that, in the embodiment of the present disclosure, the target path component may be spliced to a target adjacent position randomly selected from the candidate positions.

When the candidate location is a location other than the motion path, overlapping of the generated paths can be avoided. When the candidate location is a location having at most one neighboring edge to the motion path, generating double-width paths can be avoided, helping to conserve path components.

FIG. 4 is a schematic diagram of updating a motion path according to an embodiment of the present disclosure. Referring to FIG. 4, a motion path is obtained by sequentially splicing A1, A2, A3, and A4, and at this time, a target path component A5 may be spliced to a target adjacent position of A4. In selecting the target adjacent position, the adjacent position of A4 is acquired first: L1 to L6, the position where A2 is located, and the position where A3 is located, and then the positions other than the motion path and the positions having at most one neighboring edge to the motion path are selected from these adjacent positions to get the candidate positions: L2, L3, L4, L5, and L6. Thus, a target adjacent position can be randomly selected from the candidate positions to splice A5.

As can be seen, by the process shown in FIG. 4 above, on the one hand, it can be avoided that A5 is spliced to the position of A2, A3, resulting in overlapping of the motion paths at the position where A2 or A3 is located. It can also be avoided that A5 is spliced at L1, and thus that the motion path is a double width comprising A2, A3, A4, and A4 at L1, which saves the path components and helps to improve the effective utilization of the path components.

In the embodiment of the present disclosure, the correspondence between the facial feature data and the current motion velocity may also be presented in the display interface. In this way, the user can be assisted to better control the motion of the display object based on the correspondence.

For the foregoing facial feature data, when the facial feature data is a two-dimensional coordinate of a facial feature point, a vector between an origin point in a two-dimensional coordinate system and the facial feature point may be presented. When the facial feature data is a facial rotation angle, a facial rotation direction and/or angle may be presented.

With regard to the described current motion velocity, the current motion velocity can be presented at a current position of a display object, comprising at least one of the following: the direction of the current motion velocity and the magnitude of the current motion velocity.

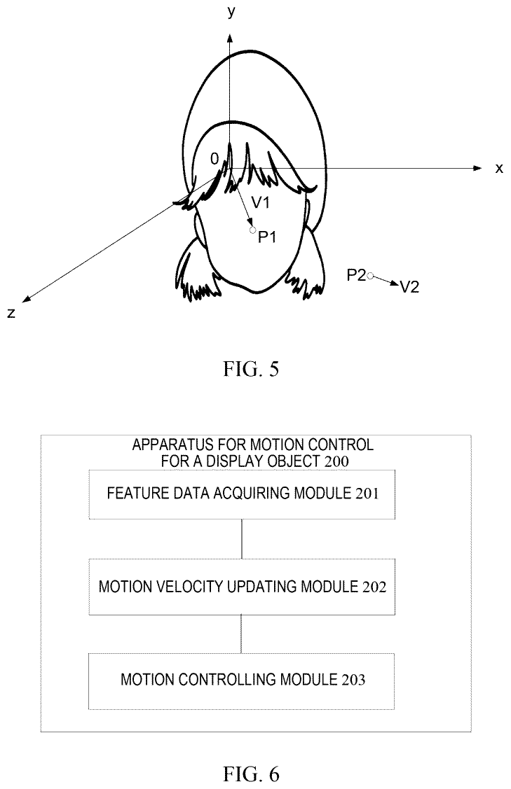

FIG. 5 is a schematic diagram of correspondence between two-dimensional coordinates of a facial feature point and a current motion direction of a display object according to an embodiment of the present disclosure. Referring to FIG. 5, V1 is a vector from an origin O to a facial feature point P1, and V2 is a current motion velocity at which the display object is presented at a current position P2.

Embodiments of the present disclosure provide a method and device method of motion control for a display object. The method comprises: acquiring facial feature data of a user; updating a current motion velocity of the display object based on the facial feature data; and controlling the display object to move in the display interface based on the updated current motion velocity. According to the embodiments of the present disclosure, facial feature data may be first mapped onto a motion velocity, so as to control a display object to move based on the motion velocity. In this way, when facial feature data changes, a motion velocity of a display object changes, and the changing of the motion velocity can make a position of the display object after moving uncertain, thereby diversifying a relative position relationship between the display object and a face, and further improving the diversified motion of the display object.

Corresponding to the method of motion control for a display object in the above embodiments, FIG. 6 is a structural block diagram of an apparatus for motion control for a display object according to an embodiment of the present disclosure. For ease of description, only parts related to the embodiments of the present disclosure are shown. Referring to FIG. 6, the apparatus 200 for motion control for a display object comprises: a feature data acquiring module 201, a motion velocity updating module 202, and a motion controlling module 203.

Herein, the feature data acquiring module 201 is configured to acquire facial feature data of a user.

The motion velocity updating module 202 is configured to update a current motion velocity of the display object based on the facial feature data.

The motion controlling module 203 is configured to control the display object to move in the display interface based on the updated current motion velocity.

Optionally, the motion velocity updating module 202 is further configured to:
convert the facial feature data into a target motion velocity of the display object; and
update the current motion velocity of the display object based on the target motion velocity.

Optionally, t the facial feature data comprises at least one piece of the following one-dimensional sub-data: two-dimensional coordinate values of a facial feature point, a facial rotation angle on at least one plane, and a size of a facial region; and the target motion velocity comprises components in at least two dimensions, a component in at least one of the dimensions being associated with at least one piece of the sub-data.

Optionally, the motion velocity updating module 202 is further configured to:
convert, for one of the dimensions, at least one piece of the sub-data as a component of the target motion velocity in the dimension, the converting comprising at least one of linear conversion or non-linear conversion

Optionally, the motion velocity updating module 202 is further configured to:
for one of the dimensions, if the component of the target motion velocity in the dimension is greater than a component of the current motion velocity in the dimension, increase the component of the current motion velocity in the dimension by a predetermined first acceleration, the first acceleration being greater than 0; and
if the component of the target motion velocity in the dimension is less than the component of the current motion velocity in the dimension, decrease the component of the current motion velocity in the dimension by a predetermined second acceleration, the second acceleration being less than 0.

Optionally, the apparatus further comprises:
a path component acquiring module configured to acquire a predetermined number of path components;
a motion path generating module configured to generate a motion path of the display object based on the path components.

Optionally, the motion path generating module is further configured to:
generate the motion path based on one of the path components;
if the predetermined number of path components comprise an unused path component, determine one of the unused path components as a target path component;
if the predetermined number of path components do not comprise an unused path component, determine a nearest path component in the motion path as a target path component, the nearest path component being a path component with a maximum target splicing time, target splicing time of each path component being a time corresponding to a latest splicing of the corresponding path component to the motion path; and
splice the target path component to a target adjacent position of a farthest path component in the motion path to obtain an updated motion path, the farthest path component being a path component with a minimum target splicing time.

Optionally, the motion path generating module is further configured to:
in response to the display object being located at a target intermediate position of the motion path, splice the target path component to a target adjacent position of the farthest path component in the motion path, the target intermediate position comprising a further position in the motion path other than the farthest path component.

Optionally, the motion path generating module is further configured to:
acquire at least one adjacent position of the farthest path component in the motion path;
if at least one candidate position is present among the at least one adjacent position, select one position randomly from the at least one candidate position as the target adjacent position, the at least one candidate position comprising at least one of: a position other than a current position of the individual path component, or a position having at most one neighboring edge to the motion path; and
splice the target path component to the target adjacent position.

Optionally, the apparatus further comprises:
a correspondence presenting module configured to present a correspondence between the facial feature data and the current motion velocity.

Optionally, components of the target motion velocity in three dimensions comprise: the two-dimensional coordinate values of the facial feature point, and the size of the facial region; or the component of the target motion velocity in three dimensions is: a facial rotation angle on at least one plane.

This embodiment provides an apparatus for motion control for a display object, which may be used to execute the technical solution of the method embodiment shown in FIG. 2. Implementation principles and technical effects of the motion control apparatus are similar to those of the method embodiment shown in FIG. 2, and details are not repeatedly described herein in this embodiment.

FIG. 7 is a structural block diagram of an electronic device 600 according to an embodiment of the present disclosure. The electronic device 600 comprises a memory 602 and at least one processor 601.

Herein, the memory 602 stores computer execution instructions.

The at least one processor 601 executes computer execution instructions stored in the memory 602 to cause the electronic device 601 to implement the method in FIG. 2.

In addition, the electronic device can further comprise a receiver 603 and a transmitter 604, the receiver 603 being configured to receive information from other apparatuses or devices and forward the information to the processor 601, and the transmitter 604 being configured to send the information to the other apparatuses or devices.

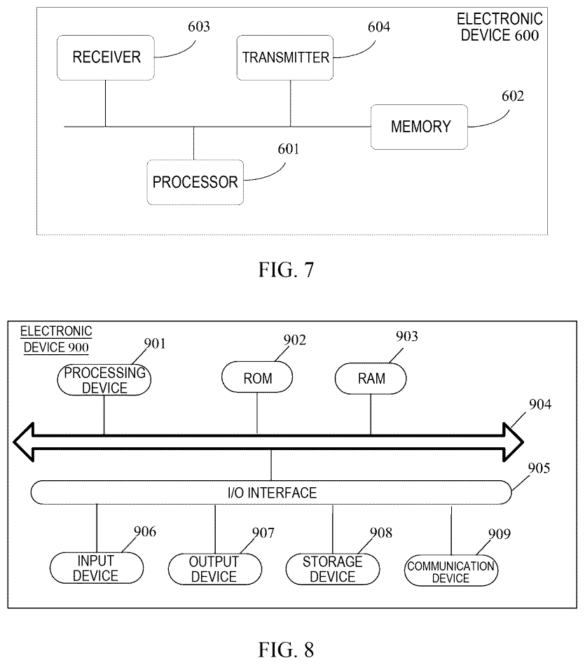

Further, with reference to FIG. 8, which illustrates a schematic diagram of a structure of an electronic device 900 suitable for use in implementing embodiments of the present disclosure, the electronic device 900 may be a terminal device. Herein, the terminal device may comprise, but is not limited to, a device such as a cell phone, a laptop computer, a digital broadcast receiver, a Personal Digital Assistant (PDA), a tablet computer (Portable Android Device (PAD)), a portable multimedia player (Portable Media Player (PMP), in-vehicle terminal (e.g., in-vehicle navigation terminal), and the like mobile terminals, and fixed terminals such as digital TVs, desktop computers, and the like. The electronic device illustrated in FIG. 8 is merely an example and should not impose any limitation on the functions and scope of use of the embodiments of the present disclosure.

As shown in FIG. 8, the electronic device 900 may comprise a processing device (e.g., a central processor, a graphics processor, etc.) 901 that may execute various programs based on a program stored in a Read Only Memory (ROM) 902 or loaded from a storage device 908 into a Random Access Memory (RAM) 903 to perform various appropriate actions and processes. Also stored in the RAM 903 are various programs and data necessary for the operation of the electronic device 900. The processing device 901, the ROM 902, and the RAM 903 are connected to each other via a bus 904. Input/output (I/O) interfaces 905 are also connected to the bus 904.

In general, the following devices may be connected to the I/O interface 905: an input device 906 comprising, for example, a touch screen, a touch pad, a keyboard, a mouse, a camera, a microphone, an accelerometer, a gyroscope, or the like; an output device 907 comprising, for example, a liquid crystal display (LCD), a speaker, a vibrator, or the like; a storage device 908 comprising, for example, a magnetic tape, a hard disk, or the like; and a communication device 909. Communication device 909 may allow electronic device 900 to communicate wirelessly or wired with other devices to exchange data. While FIG. 8 illustrates an electronic device 900 having various devices, it is to be understood that not all of the illustrated devices are required to be implemented or provided. More or fewer devices may alternatively be implemented or provided.

In particular, according to embodiments of the present disclosure, the process described above with reference to the flowchart may be implemented as a computer software program. For example, embodiments of the present disclosure include a computer program product including a computer program carried on a computer readable medium, the computer program comprising program code for performing the method shown in the flowchart. In such embodiments, the computer program may be downloaded and installed from a network via a communication device 909, or from a storage device 908, or from a ROM 902. When this computer program is executed by the processing device 901, the above-described functions defined in the methods of embodiments of the present disclosure are performed.

Embodiments of the present disclosure also comprise a computer program which, when executed by a processor, implements the above-described functions of the method defined in embodiments of the present disclosure.

It is noted that the computer-readable medium described above in the present disclosure may be a computer-readable signal medium or a computer-readable storage medium or any combination of the above. The computer-readable storage medium may, for example, be-but is not limited to-a system, device, or apparatus or device of electricity, magnetism, light, electromagnetism, infrared, or semiconductors, or any combination of the above. More specific examples of computer-readable storage media may include but are not limited to: electrical connections having one or more wires, portable computer disks, hard disks, random access memory (RAM), read-only memory (ROM), erasable programmable read-only memory (EPROM or flash memory), optical fibers, portable compact disk read-only memories (CD-ROM), optical storage devices, magnetic memory device, or any suitable combination of the foregoing. In the context of the present disclosure, a computer-readable storage medium may be any tangible medium containing or storing a program that may be used by or in combination with an instruction execution system, apparatus, or device. And in the context of the present disclosure, a computer-readable signal medium may include a data signal propagated in a baseband or as part of a carrier that carries computer-readable program code. Such propagated data signals may take a variety of forms, including, but not limited to, electromagnetic signals, optical signals, or any suitable combination of the foregoing. The computer-readable signal medium may also be any computer-readable medium other than a computer-readable storage medium that sends, propagates, or transmits a program for use by, or in combination with, an instruction-executing system, apparatus, or device. The program code contained on the computer-readable medium may be transmitted using any suitable medium, including, but not limited to: wire, fiber optic cable, RF (radio frequency), etc., or any suitable combination of the foregoing.

The above-described computer-readable medium may be included in the above-described electronic device; or it may be present separately and not assembled into the electronic device.

The computer-readable medium carries one or more programs which, when the one or more programs are executed by the electronic device, cause the electronic device to execute the method of the above embodiment.

Computer program code for performing the operations of the present disclosure may be written in one or more programming languages or combinations thereof, including object-oriented programming languages-such as Java, Smalltalk, C++—and conventional procedural programming languages—such as the “C” language or the like. “C” or similar programming languages. The program code may be executed entirely on the user's computer, partially on the user's computer, as a stand-alone software package, partially on the user's computer and partially on a remote computer, or entirely on a remote computer or server. In situations involving a remote computer, the remote computer may be connected to the user computer via any kind of network-including a Local Area Network (LAN) or a Wide Area Network (WAN)—or, alternatively, may be connected to an external computer. The remote computer may be connected to the user's computer via any kind of network-including a Local Area Network (LAN) or a Wide Area Network (WAN)—or, alternatively, it may be connected to an external computer (e.g., by utilizing an Internet Service Provider to connect via the Internet).

The flowcharts and block diagrams in the accompanying drawings illustrate the architecture, functionality, and operation of systems, methods, and computer program products that may be implemented in accordance with various embodiments of the present disclosure. At this point, each box in the flowcharts or block diagrams may represent a module, program segment, or portion of code that contains one or more executable instructions for implementing a specified logical function. It should also be noted that in some implementations as replacements, the functions labeled in the boxes may also occur in a different order than those labeled in the accompanying drawings. For example, two consecutively represented boxes may actually be executed substantially in parallel, and they may sometimes be executed in reverse order, depending on the function involved. It is also noted that each of the boxes in the block diagrams and/or flowcharts, and combinations of the boxes in the block diagrams and/or flowcharts, may be implemented with a specialized hardware-based system that performs the specified function or operation, or may be implemented with a combination of specialized hardware and computer instructions.

The units described in the embodiments of the present disclosure may be implemented by way of software or by way of hardware. The name of the unit does not, in some cases, constitute a limitation of the unit itself, e.g., the first acquisition unit may also be described as “a unit for acquiring at least two Internet Protocol addresses”.

The functions described above herein may be performed, at least in part, by one or more hardware logic components. For example, without limitation, exemplary types of hardware logic components that may be used include: field programmable gate arrays (FPGAs), application-specific integrated circuits (ASICs), application-specific standard products (ASSPs), systems-on-chip (SOCs), complex programmable logic devices (CPLDs), and the like.

In the context of the present disclosure, a machine-readable medium may be a tangible medium that may include or store a program for use by or in conjunction with an instruction execution system, device, or apparatus. The machine-readable medium may be a machine-readable signal medium or a machine-readable storage medium. The machine-readable medium may include, but is not limited to, an electronic, magnetic, optical, electromagnetic, infrared, or semiconductor system, device, or apparatus, or any suitable combination of the foregoing. More specific examples of machine-readable storage media would include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination of the foregoing. any suitable combination of the above.

In a first example of the first aspect, embodiments of the present disclosure provide a method of motion control for a display object, comprising:
acquiring facial feature data of a user;
updating a current motion velocity of the display object based on the facial feature data; and
controlling the display object to move in the display interface based on the updated current motion velocity.

Based on the first example of the first aspect, in a second example of the first aspect, the updating a current motion velocity of the display object based on the facial feature data comprises:
converting the facial feature data into a target motion velocity of the display object; and
updating the current motion velocity of the display object based on the target motion velocity.

Based on the second example of the first aspect, in a third example of the first aspect, the facial feature data comprises at least one piece of the following one-dimensional sub-data: two-dimensional coordinate values of a facial feature point, a facial rotation angle on at least one plane, and a size of a facial region; and the target motion velocity comprises components in at least two dimensions, a component in at least one of the dimensions being associated with at least one piece of the sub-data.

Based on the third example of the first aspect, in a fourth example of the first aspect, the converting the facial feature data into a target motion velocity of the display object comprises:
converting, for one of the dimensions, at least one piece of the sub-data as a component of the target motion velocity in the dimension, the converting comprising at least one of linear conversion or non-linear conversion.

Based on the third or fourth example of the first aspect, in a fifth example of the first aspect, the updating the current motion velocity of the display object based on the target motion velocity comprises:
for one of the dimensions, if the component of the target motion velocity in the dimension is greater than a component of the current motion velocity in the dimension, increasing the component of the current motion velocity in the dimension by a predetermined first acceleration, the first acceleration being greater than 0; and
if the component of the target motion velocity in the dimension is less than the component of the current motion velocity in the dimension, decreasing the component of the current motion velocity in the dimension by a predetermined second acceleration, the second acceleration being less than 0.

Based on the first to fourth examples of the first aspect, in a sixth example of the first aspect, the method further comprises:
acquiring a predetermined number of path components; and
generating a motion path of the display object based on the path components.

Based on the sixth example of the first aspect, in a seventh example of the first aspect, generating a motion path of the display object based on the path components comprises:
generating the motion path based on one of the path components;
if the predetermined number of path components comprise an unused path component, determining one of the unused path components as a target path component;
if the predetermined number of path components do not comprise an unused path component, determining a nearest path component in the motion path as a target path component, the nearest path component being a path component with a maximum target splicing time, target splicing time of each path component being a time corresponding to a latest splicing of the corresponding path component to the motion path; and
splicing the target path component to a target adjacent position of a farthest path component in the motion path to obtain an updated motion path, the farthest path component being a path component with a minimum target splicing time.

Based on the seventh example of the first aspect, in an eighth example of the first aspect, the splicing the target path component to a target adjacent position of a farthest path component in the motion path comprises:
in response to the display object being located at a target intermediate position of the motion path, splicing the target path component to a target adjacent position of the farthest path component in the motion path, the target intermediate position comprising a further position in the motion path other than the farthest path component.

Based on an eighth example of the first aspect, in a ninth example of the first aspect, the splicing the target path component to a target adjacent position of the farthest path component of the motion path comprises:
acquiring at least one adjacent position of the farthest path component in the motion path;
if at least one candidate position is present among the at least one adjacent position, selecting one position randomly from the at least one candidate position as the target adjacent position, the at least one candidate position comprising at least one of: a position other than a current position of the individual path component, or a position having at most one neighboring edge to the motion path; and
splicing the target path component to the target adjacent position.

Based on the second to fourth examples of the first aspect, in a tenth example of the first aspect, the method further comprises:
presenting a correspondence between the facial feature data and the current motion velocity.

Based on the third example of the first aspect, in an eleventh example of the first aspect, components of the target motion velocity in three dimensions comprise: the two-dimensional coordinate values of the facial feature point, and the size of the facial region; or the component of the target motion velocity in three dimensions is: a facial rotation angle on at least one plane.

In a first example of the second aspect, embodiments of the present disclosure provide an apparatus for motion control for a display object, comprising:
a feature data acquiring module configured to acquire facial feature data of a user;
a motion velocity updating module configured to update a current motion velocity of the display object based on the facial feature data; and
a motion controlling module configured to control the display object to move in the display interface based on the updated current motion velocity.

According to a first example of the second aspect, in a second example of the second aspect, the motion velocity updating module is further configured to:
convert the facial feature data into a target motion velocity of the display object; and
update the current motion velocity of the display object based on the target motion velocity.

According to a second example of the second aspect, in a third example of the second aspect, the facial feature data comprises at least one piece of the following one-dimensional sub-data: two-dimensional coordinate values of a facial feature point, a facial rotation angle on at least one plane, and a size of a facial region; and the target motion velocity comprises components in at least two dimensions, a component in at least one of the dimensions being associated with at least one piece of the sub-data.

According to the third example of the second aspect, in a fourth example of the second aspect, the motion velocity updating module is further configured to:
convert, for one of the dimensions, at least one piece of the sub-data as a component of the target motion velocity in the dimension, the converting comprising at least one of linear conversion or non-linear conversion.

According to the third or fourth example of the second aspect, in a fifth example of the second aspect, the motion velocity updating module is further configured to:
for one of the dimensions, if the component of the target motion velocity in the dimension is greater than a component of the current motion velocity in the dimension, increase the component of the current motion velocity in the dimension by a predetermined first acceleration, the first acceleration being greater than 0; and
if the component of the target motion velocity in the dimension is less than the component of the current motion velocity in the dimension, decrease the component of the current motion velocity in the dimension by a predetermined second acceleration, the second acceleration being less than 0.

According to the first to fourth examples of the second aspect, in a sixth example of the second aspect, the apparatus further comprises:
a path component acquiring module configured to acquire a predetermined number of path component;
a motion path generating module configured to generate a motion path of the display object based on the path component.

According to the sixth example of the second aspect, in a seventh example of the second aspect, the motion path generating module is further configured to:
generate the motion path based on one of the path components;
if the predetermined number of path components comprise an unused path component, determining one of the unused path components as a target path component;
if the predetermined number of path components do not comprise an unused path component, determine a nearest path component in the motion path as a target path component, the nearest path component being a path component with a maximum target splicing time, target splicing time of each path component being a time corresponding to a latest splicing of the corresponding path component to the motion path; and
splice the target path component to a target adjacent position of a farthest path component in the motion path to obtain an updated motion path, the farthest path component being a path component with a minimum target splicing time.

According to the seventh example of the second aspect, in an eighth example of the second aspect, the motion path generating module is further configured to:
in response to the display object being located at a target intermediate position of the motion path, splice the target path component to a target adjacent position of the farthest path component in the motion path, the target intermediate position comprising a further position in the motion path other than the farthest path component.

According to the eighth example of the second aspect, in a ninth example of the second aspect, the motion path generating module is further configured to:
acquire at least one adjacent position of the farthest path component in the motion path;
if at least one candidate position is present among the at least one adjacent position, select one position randomly from the at least one candidate position as the target adjacent position, the at least one candidate position comprising at least one of: a position other than a current position of the individual path component, or a position having at most one neighboring edge to the motion path; and
splice the target path component to the target adjacent position.

According to second to fourth examples of the second aspect, in a tenth example of the second aspect, the apparatus further comprises:
a correspondence presenting module configured to present a correspondence between the facial feature data and the current motion velocity.

According to the third example of the second aspect, in an eleventh example of the second aspect, components of the target motion velocity in three dimensions comprise: the two-dimensional coordinate values of the facial feature point, and the size of the facial region; or the component of the target motion velocity in three dimensions is: a facial rotation angle on at least one plane.

In a third aspect, according to one or more embodiments of the present disclosure, there is provided an electronic device, comprising: at least one processor and a memory;
the memory stores computer execution instructions; and
the at least one processor executes computer execution instructions stored in the memory to cause the electronic device to implement the method off the first aspect.

In a fourth aspect, a computer-readable storage medium having computer execution instructions stored therein, the computer execution instructions, when executed by a processor, causing a computing device to implement the method of the first aspect.

In a fifth aspect, according to one or more embodiments of the present disclosure, a computer program product comprising a computer program is provided for implementing the method of the first aspect.

In a sixth aspect, according to one or more embodiments of the present disclosure, a computer program comprising a computer program is provided for implementing the method of the first aspect.

The above description is only a preferred embodiment of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept. For example, a technical solution formed by interchanging the above-mentioned features with technical features having similar functions disclosed in the present disclosure (but not limited to).

Furthermore, although the operations are depicted using a particular order, this should not be construed as requiring that the operations be performed in the particular order shown or in a sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logic actions, it should be understood that the subject matter defined in the appended claims is not necessarily limited to the particular features or actions described above. Rather, the particular features and actions described above are merely exemplary forms of realizing the claims.

1. A method of motion control for a display object, comprising:
acquiring facial feature data of a user;
updating a current motion velocity of the display object based on the facial feature data; and
controlling the display object to move in the display interface based on the updated current motion velocity.

2. The method of claim 1, wherein the updating a current motion velocity of the display object based on the facial feature data comprises:
converting the facial feature data into a target motion velocity of the display object; and
updating the current motion velocity of the display object based on the target motion velocity.

3. The method of claim 2, wherein the facial feature data comprises at least one piece of the following one-dimensional sub-data: two-dimensional coordinate values of a facial feature point, a facial rotation angle on at least one plane, and a size of a facial region; and
the target motion velocity comprises components in at least two dimensions, a component in at least one of the dimensions being associated with at least one piece of the sub-data.

4. The method of claim 3, wherein the converting the facial feature data into a target motion velocity of the display object comprises:
converting, for one of the dimensions, at least one piece of the sub-data as a component of the target motion velocity in the dimension, the converting comprising at least one of linear conversion or non-linear conversion.

5. The method of claim 3, wherein the updating the current motion velocity of the display object based on the target motion velocity comprises:
for one of the dimensions, if the component of the target motion velocity in the dimension is greater than a component of the current motion velocity in the dimension, increasing the component of the current motion velocity in the dimension by a predetermined first acceleration, the first acceleration being greater than 0; and
if the component of the target motion velocity in the dimension is less than the component of the current motion velocity in the dimension, decreasing the component of the current motion velocity in the dimension by a predetermined second acceleration, the second acceleration being less than 0.

6. The method of claim 1, the method further comprising:
acquiring a predetermined number of path components; and
generating a motion path of the display object based on the path components.

7. The method of claim 6, wherein generating a motion path of the display object based on the path components comprises:
generating the motion path based on one of the path components;
if the predetermined number of path components comprise at least one unused path component, determining one of the at least one unused path components as a target path component;
if the predetermined number of path components do not comprise an unused path component, determining a nearest path component in the motion path as a target path component, the nearest path component being a path component with a maximum target splicing time, target splicing time of each path component being a time corresponding to a latest splicing of the corresponding path component to the motion path; and
splicing the target path component to a target adjacent position of a farthest path component in the motion path to obtain an updated motion path, the farthest path component being a path component with a minimum target splicing time.

8. The method of claim 7, wherein the splicing the target path component to a target adjacent position of a farthest path component in the motion path comprises:
in response to the display object being located at a target intermediate position of the motion path, splicing the target path component to a target adjacent position of the farthest path component in the motion path, the target intermediate position comprising a further position in the motion path other than the farthest path component.

9. The method of claim 8, wherein the splicing the target path component to a target adjacent position of the farthest path component of the motion path comprises:
acquiring at least one adjacent position of the farthest path component in the motion path;
if at least one candidate position is present among the at least one adjacent position, selecting one position randomly from the at least one candidate position as the target adjacent position, the at least one candidate position comprising at least one of: a position other than a current position of the individual path component, or a position having at most one neighboring edge to the motion path; and
splicing the target path component to the target adjacent position.

10. The method of claim 2, the method further comprising:
presenting a correspondence between the facial feature data and the current motion velocity.

11. The method of claim 3, wherein
components of the target motion velocity in three dimensions comprise: the two-dimensional coordinate values of the facial feature point, and the size of the facial region; or
wherein the component of the target motion velocity in three dimensions is: a facial rotation angle on at least one plane.

12. (canceled)

13. An electronic device, comprising: at least one processor and a memory; wherein
the memory stores computer execution instructions; and
the at least one processor executes computer execution instructions stored in the memory to cause the electronic device to implement the acts comprising:
acquiring facial feature data of a user;
updating a current motion velocity of the display object based on the facial feature data; and
controlling the display object to move in the display interface based on the updated current motion velocity.

14. A non-transitory computer-readable storage medium having computer execution instructions stored therein, the computer execution instructions, when executed by a processor, causing a computing device to implement acts comprising:
acquiring facial feature data of a user;
updating a current motion velocity of the display object based on the facial feature data; and
controlling the display object to move in the display interface based on the updated current motion velocity.

15-16. (canceled)

17. The electronic device of claim 13, wherein the updating a current motion velocity of the display object based on the facial feature data comprises:
converting the facial feature data into a target motion velocity of the display object; and
updating the current motion velocity of the display object based on the target motion velocity.

18. The electronic device of claim 13, wherein the facial feature data comprises at least one piece of the following one-dimensional sub-data: two-dimensional coordinate values of a facial feature point, a facial rotation angle on at least one plane, and a size of a facial region; and
the target motion velocity comprises components in at least two dimensions, a component in at least one of the dimensions being associated with at least one piece of the sub-data.

19. The electronic device of claim 18, wherein the converting the facial feature data into a target motion velocity of the display object comprises:
converting, for one of the dimensions, at least one piece of the sub-data as a component of the target motion velocity in the dimension, the converting comprising at least one of linear conversion or non-linear conversion.

20. The electronic device of claim 18, wherein the updating the current motion velocity of the display object based on the target motion velocity comprises:
for one of the dimensions, if the component of the target motion velocity in the dimension is greater than a component of the current motion velocity in the dimension, increasing the component of the current motion velocity in the dimension by a predetermined first acceleration, the first acceleration being greater than 0; and
if the component of the target motion velocity in the dimension is less than the component of the current motion velocity in the dimension, decreasing the component of the current motion velocity in the dimension by a predetermined second acceleration, the second acceleration being less than 0.

21. The electronic device of claim 13, wherein the acts further comprise:
acquiring a predetermined number of path components; and
generating a motion path of the display object based on the path components.

22. The electronic device of claim 21, wherein generating a motion path of the display object based on the path components comprises:
generating the motion path based on one of the path components;
if the predetermined number of path components comprise at least one unused path component, determining one of the at least one unused path component as a target path component;
if the predetermined number of path components do not comprise an unused path component, determining a nearest path component in the motion path as a target path component, the nearest path component being a path component with a maximum target splicing time, target splicing time of each path component being a time corresponding to a latest splicing of the corresponding path component to the motion path; and
splicing the target path component to a target adjacent position of a farthest path component in the motion path to obtain an updated motion path, the farthest path component being a path component with a minimum target splicing time.

23. The electronic device of claim 22, wherein the splicing the target path component to a target adjacent position of a farthest path component in the motion path comprises:
in response to the display object being located at a target intermediate position of the motion path, splicing the target path component to a target adjacent position of the farthest path component in the motion path, the target intermediate position comprising a further position in the motion path other than the farthest path component.
